(19) United States
(12) Patent Application Publication
(10) Pub. No.: US 2026/0187468 A1
(43) Pub. Date: Jul. 2, 2026

(54) METHOD AND SYSTEM FOR ENTITY DISAMBIGUATION AND FORGETTING BASED ON LARGE LANGUAGE MODEL

(71) Applicant: JINAN UNIVERSITY, Guangzhou (CN)

(72) Inventors: Feiran Huang, Guangzhou (CN); Chong Xu, Guangzhou (CN); Zhibo Zhou, Guangzhou (CN); Wenxiao Liu, Guangzhou (CN); Zhiquan Liu, Guangzhou (CN); Miaomiao Chen, Guangzhou (CN)

(21) Appl. No.: 19/373,078

(22) Filed: Oct. 29, 2025

(30) Foreign Application Priority Data
Dec. 26, 2024 (CN) 202411932523.X

(51) Int. Cl. G06N 3/0895; G06F 40/126; G06N 3/045

(52) U.S. Cl. CPC G06N 3/0895; G06F 40/126; G06N 3/045

(57) ABSTRACT

A method and a system for entity disambiguation and forgetting based on a large language model are provided. The method includes: determining an entity disambiguation dataset and a forgetting dataset, constructing a contrastive learning sample, performing data preprocessing; extracting a feature using a LLaMA3 model, adding a projection layer and a contrastive learning module; by constructing a loss function, for each sample, calculating a similarity between its feature representation and positive and negative samples using cosine similarity, measuring an effectiveness of the model in distinguishing positive and negative samples by using contrastive loss, updating model parameters through backpropagation until the model is converged. The present disclosure enhances the discriminative ability of the model based LLaMA3 model architecture and contrastive learning and provides a way to implement a forgetting mechanism. The present disclosure provides new ideas for the research and application of models in the field of natural language processing.

### CROSS-REFERENCE TO RELATED APPLICATIONS

This application claims priority to Chinese Patent Application No. 202411932523.X, filed on Dec. 26, 2024, which is hereby incorporated by reference in its entirety.

### TECHNICAL FIELD

The present disclosure relates to the field of entity disambiguation in natural language processing technologies, and in particular, to a method and a system for entity disambiguation and forgetting based on a large language model.

### BACKGROUND

With an explosive growth of Internet information, text data contains many ambiguous entities. Accurate entity disambiguation is crucial for information retrieval, question answering system, text summarization and other applications. Modern applications, such as search engines, knowledge graph construction, question answering systems, and virtual assistants, rely on precise identification and disambiguation of entities to provide users with the accurate information they need. Entity disambiguation has become an urgent need for models to accurately understand and remember entities. However, the task of disambiguation is full of challenges, especially when facing entities with the same name (such as company and place names being the same) and polysemous words (the same word having different meanings). Besides that, during an entity disambiguation process, the model may handle entities that contain personal privacy information (such as names, geographical locations, etc.). According to data privacy regulations, the users have right to request the deletion of their personal data. The entity disambiguation and forgetting method based on the large language model provides an efficient solution for recognizing and distinguishing entities with multiple meanings in a large amount of text and forgetting specific entity information. It provides the users with the information they need, ensures its accuracy and completeness, and complies with data privacy regulations. Its importance is particularly prominent in search engines, knowledge graph construction, question answering systems, and virtual assistants, and it has a very wide range of application scenarios.

Previous machine learning based entity disambiguation methods mostly used machine learning models such as Support Vector Machine, (SVM) and decision trees to encode entities and their context as features and classify them. The drawbacks of these methods are that: 1. Classic machine learning models usually require a lot of manual feature engineering to extract effective features for training. This is not only time-consuming and labor-intensive, but also the quality of feature design directly affects model performance. Manual features are difficult to capture complex semantic and contextual information, which limits the expressive power of the model. 2. Compared to modern large language models, classical machine learning models have significant shortcomings in understanding and utilizing contextual information, rendering it difficult to capture long-range dependencies and complex contextual relationships. 3. For entities with high ambiguity, classical models often struggle to effectively distinguish their specific meanings. This is because classical models rely on predefined features and lack understanding of the deep semantics of entities, which results in poor performance when faced with complex ambiguities.

### SUMMARY

In order to solve the above problems, the purpose of the present disclosure is to provide an entity disambiguation and forgetting technology based on a large language model, using a Large Language Model Meta AI, (LLaMA)3 model as a basic architecture, fundamentally solving many defects exposed by previous classic machine learning models (SVM, decision tree). The present disclosure combines contrastive learning, and the model automatically learns how to bring different contextual representations of the same entity closer and push different entity representations farther, significantly enhancing the disambiguation ability. Besides that, contrastive learning enhances the model's ability to distinguish entities by constructing positive and negative sample pairs, dynamically learning new entity features, adapting to new contexts, and effectively forgetting specific entity information.

In order to achieve the above technical objectives, the present application provides an entity disambiguation and forgetting method based on a large language model, including the following steps:
constructing a contrastive learning sample based on an entity disambiguation dataset and a forgetting dataset, performing data preprocessing to remove irrelevant information; segmenting and encoding text by using a vocabulary of a LLaMA3 model, and generating a dataset;
adding a projection layer and a contrastive learning module for improvement based on the LLaMA3 model, training a model on the dataset to construct the large language model based on improved LLaMA3 model, so that constructed large language model has both entity disambiguation and forgetting capabilities.

In some embodiments of the present disclosure, in a process of constructing a contrastive learning sample, the contrastive learning sample includes a positive sample and a negative sample, where the positive sample includes text of a target entity, a positive sample representation is obtained by encoding using the LLaMA3 model; the negative samples include two types: a first type that is text containing the entity that needs to be forgotten as an object for the model that needs to reduce similarity, and a second type including other entities that are easily confused with the target entity.

In some embodiments of the present disclosure, in a process of improving the LLaMA3 model, the projection layer is added after an output layer of the LLaMA3 model, a high-dimensional text representation is mapped to a contrastive learning space, modules that requires for contrastive learning are integrated, and this process further includes a contrastive loss calculation and positive negative sample matching.

In some embodiments of the present disclosure, in a process of model training, for each sample, a similarity between a feature representation and positive and negative samples is calculated by using cosine similarity, and an effectiveness of the model in distinguishing positive and negative samples is measured by using contrastive loss.

In some embodiments of the present disclosure, a process of measuring an effectiveness of the model in distinguishing positive and negative samples by using contrastive loss includes training a model to distinguish positive and negative samples by using InfoNCE loss in a loss function of the contrastive learning, and a formula is as follows:

$${ℒ}_{contrast} = - log \frac{exp ( sim ( {z}_{i} , {z}_{i}^{+} ) / τ )}{exp ( sim ( {z}_{i} , {z}_{i}^{+} ) / τ ) + {\sum }_{j} exp ( sim ( {z}_{i} , {z}_{j}^{-} ) / τ )}$$

where zi represents a sample i,

$${z}_{i}^{+}$$

represents a positive sample of the sample i,

$${z}_{j}^{-}$$

represents a negative sample of the sample i, and zi includes an entity that needs to be forgotten, sim(·) represents a similarity function, and τ represents temperature hyperparameter;
where the loss function InfoNCE refers to the loss function when using the InfoNCE criterion for model optimization.

In some embodiments of the present disclosure, in a process of constructing the large language model, a forgetting weighted loss function is constructed for the negative sample of the entity that needs to be forgotten; a weight of the negative sample of the entity that needs to be forgotten in the loss function is increased to prompt the model to reduce the similarity to the entity.

In some embodiments of the present disclosure, in a process of model training, model parameters are updated through backpropagation based on loss value.

The present disclosure further discloses an entity disambiguation and forgetting system based on a large language model, configured to implement the above-mentioned entity disambiguation and forgetting method based on a large language model, and the entity disambiguation and forgetting system includes:
a data processing module, configured to construct a contrastive learning sample based on an entity disambiguation dataset and a forgetting dataset, perform data preprocessing to remove irrelevant information, segment and encode text by using a vocabulary of a LLaMA3 model, and generate a dataset;
a large language model construction module, configured to add a projection layer and a contrastive learning module for improvement based on the LLaMA3 model; train a model on the dataset to construct the large language model based on improved LLaMA3 model, so that constructed large language model has both entity disambiguation and forgetting capabilities.

The present disclosure discloses the following technical effects.
(1) In the present disclosure, the LLaMA3 model severs as a basic architecture, fundamentally solving many defects exposed by previous classic machine learning models (SVM, decision tree), enabling the model to have higher efficiency in entity disambiguation and forgetting tasks, and improving the accuracy and robustness of the model.
(2) In the present disclosure, the projection layer is added after the output layer of the LLaMA3 model to map the high-dimensional text representation to the contrastive learning space. After further training through the contrastive learning module, it learns to distinguish between different entity representations, enhances entity disambiguation ability, and improves the model's ability to distinguish between different entities.
(3) The LLaMA3 model in the present disclosure has been pretrained on large-scale corpora, possessing rich language knowledge and contextual understanding ability. During the training process, the negative sample from contrastive learning is used to construct the model, reducing its sensitivity to the entity that needs to be forgotten, thus achieving the goal of forgetting. By combining the LLaMA3 large-scale language model with contrastive learning, its powerful language understanding and representation capabilities can be fully utilized, thereby improving the accuracy of entity disambiguation and achieving effective forgetting of specific entity information.

### BRIEF DESCRIPTION OF DRAWINGS

In order to more clearly illustrate the embodiments of the present disclosure or the technical solutions in the prior art, a brief introduction will be given to the drawings required for the embodiments. It is obvious that the drawings described below are only some embodiments of the present disclosure. For those skilled in the art, other drawings can be obtained based on these drawings without creative work.

FIG. 1 is a schematic diagram of an overall framework of a method for entity disambiguation and forgetting based on a large language model according to the present disclosure.

FIG. 2 is a schematic diagram of a framework for data preparation according to the present disclosure.

FIG. 3 is a schematic diagram of a framework of a LLaMA3 model according to the present disclosure.

FIG. 4 is a schematic diagram of a framework of a contrastive module according to the present disclosure.

### DESCRIPTION OF EMBODIMENTS

In order to clarify the purpose, technical solution, and advantages of the embodiments of the present application, the following will provide a clear and complete description of the technical solution in the embodiments of the present application in combination with the accompanying drawings. Obviously, the embodiments described are only a part of the embodiments of the present application, not all of them. The components of the embodiments of the present application described and illustrated in the accompanying drawings can be arranged and designed in various different configurations. Therefore, the detailed description of the embodiments of the present application provided in the accompanying drawings is not intended to limit the scope of the claimed application, but only to represent selected embodiments of the present application. Based on the embodiments of this application, all other embodiments obtained by those skilled in the art without creative work are within the protection scope of this application.

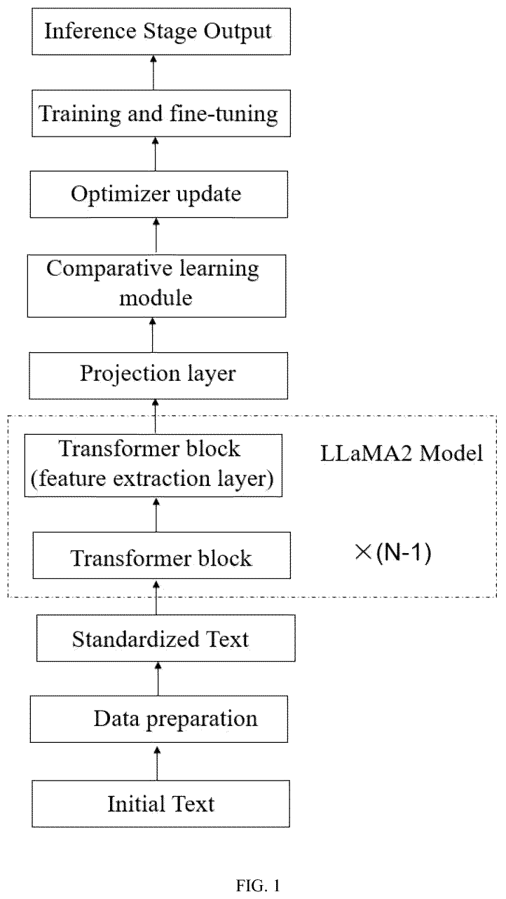

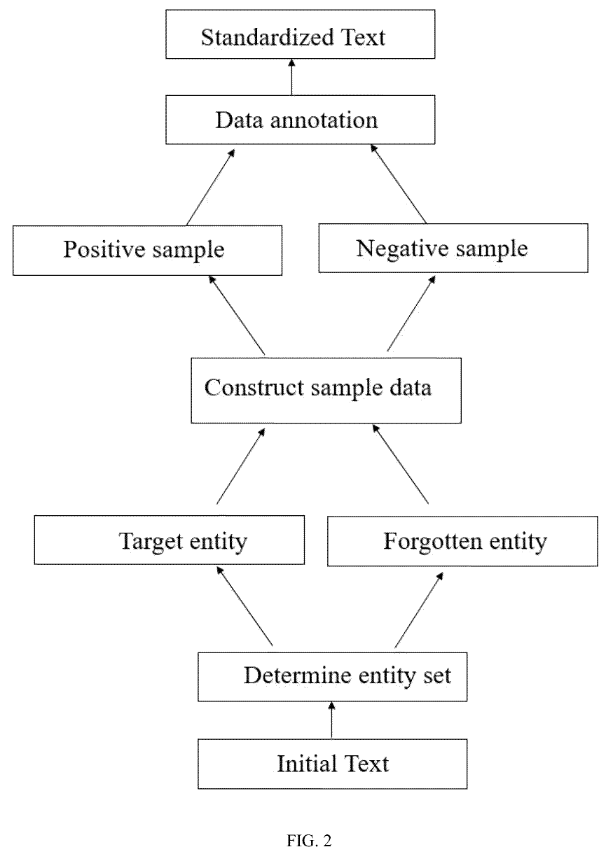

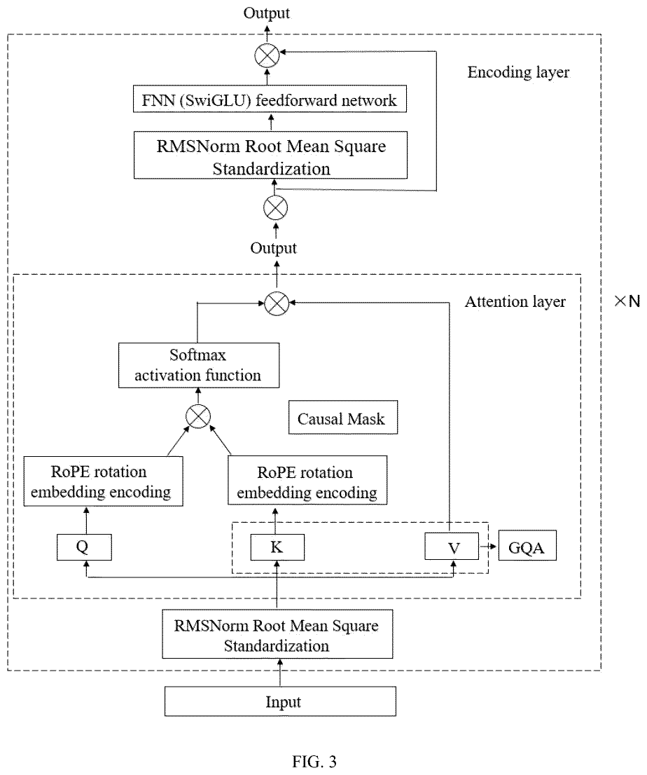

As shown in FIGS. 1-4, the present disclosure provides a method for entity disambiguation and forgetting based on a large language model, which includes the following steps:
S1: Data preparation: as shown in FIG. 2, preprocessing a given text data, including determining an entity set, constructing a sample data, annotating data, and finally obtaining standardized text.
S1: The data preparation includes the following sub steps:
S11: Determining the entity set

A target entity set refers to a set of entities that require a model to correctly identify and disambiguate; a forgetting entity set refers to a set of entities that need to be forgotten by the model, such as outdated, sensitive, or private entities.
S12: Constructing sample data

The sample data includes positive and negative samples, the positive sample is text containing a target entity, its representation is obtained by encoding using a LLaMA3 model; there are two types of negative samples, a first type containing text that needs to be forgotten as an object that the model should reduce a similarity, a second type containing other entities that are easily confused with the target entity to enhance a discriminative ability of the model.
S13: Data annotation

Using Named Entity Recognition (NER) tools such as spaCy, Bidirectional Encoder Representations from Transformers for Biomedical Text Mining, (BioBERT), and Scientific spaCy, (ScispaCy) to identify and annotate entities in text, ensuring accurate entity information for each sample. Finally, removing redundant characters, standardizing capitalization, and forming the standardized text.
S2: Model design: as shown in FIG. 1, the standardized text is input into the LLaMA3 model. After passing through a projection layer and a contrastive learning module, a total loss value is output to guide an optimization of model parameters, thereby minimizing contrastive loss and forgetting penalty.

Firstly, a tokenizer of the Large Language Model Meta AI, (LLaMA) model is used to decompose the text into word or sub word units, and the text is converted into integer representations. Then, a multi-layer Transformer encoder of the LLaMA model is used to generate context related feature representation by an attention layer and an encoding layer.
S2: The model design includes the following sub steps:
S21: Extracting a feature in the LLaMA3 model

Loading a LLaMA3 pre-trained model and utilizing its powerful text encoding capability to obtain a vector representation of text from a middle layer or a last layer of the model, and the specific steps are as follows:

Using the tokenizer of the LLaMA3 model to decompose text into word or sub word units, encoding segmentation results into an input ID, generating an attention mask, converting it into the integer representation, and preparing to input a dictionary which contains the input ID and the attention mask. The input ID marks a corresponding ID sequence, and the attention mask marks a position of an actual content. The input ID is mapped to an embedding vector to represent semantic information of the word. The input ID is then passed through an embedding layer to obtain an initial word vector representation, which is the embedding representation. The position information is then added to the embedding representation, and after passing through the attention layer and encoding layer, the multi-layer Transformer encoder of the LLaMA model generates the context related feature representation.
S22: Adding a contrastive learning module

Adding a projection layer after an output layer of the LLaMA3 model to map a high-dimensional text representation to a contrastive learning space, the modules required for contrastive learning are integrated, and this process includes a contrastive loss calculation, positive and negative sample matching, etc., and specific steps are as follows:

Using a sequence level feature representation generated in S21 as an input, a linear layer (projection layer) is used to map a high-dimensional vector to a low dimensional representation space, and a nonlinear activation function (such as Rectified Linear Unit, (ReLU)) is added to enhance a representation ability, generating the low dimensional feature representation, which is a numerical vector suitable for contrastive learning.

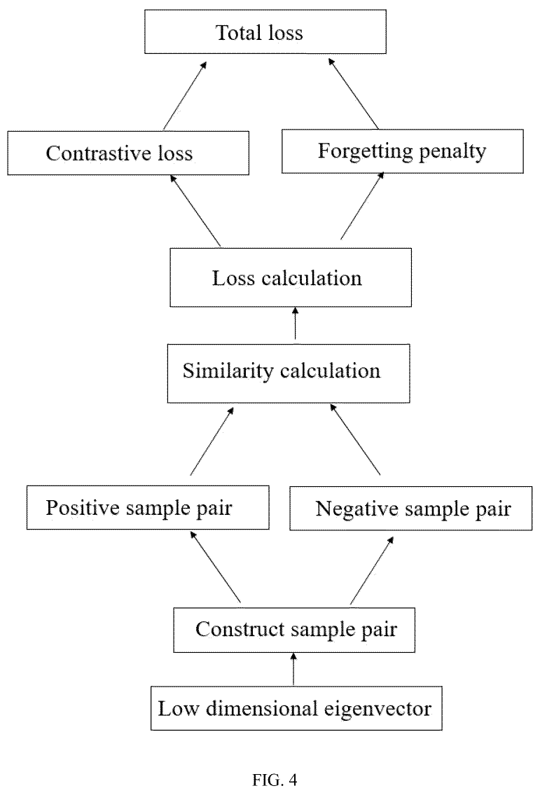

As shown in FIG. 4, the low dimensional feature representation is used as the input, the contrastive learning module is used to construct a sample pair, including positive and negative sample pairs. Then, cosine similarity is used to calculate a similarity. For the positive sample pair, a similarity between the positive sample pair is narrowed to enhance the recognition ability of the model for the same entity. For the negative sample pair, a similarity between the negative sample pair is extended to improve the model's ability to distinguish different entities, especially for an entity that needs to be forgotten. Finally, a loss value and a forgetting loss are calculated to obtain the total loss value, which is used to guide the optimization of model parameters and minimize the contrastive loss and the forgetting penalty.
S3: Constructing a loss function: multiple functions are used for calculation in S22, this process includes contrastive loss function, forgetting loss function, and loss adjustment of forgetting mechanism.
S3: Constructing the loss function, with specific details as follows:
S31: Contrastive Loss Function

Using InfoNCE loss of the contrastive learning loss function to train a model to distinguish between positive and negative samples, and a formula is as follows:

$${ℒ}_{contrast} = - log \frac{exp ( sim ( {z}_{i} , {z}_{i}^{+} ) / τ )}{exp ( sim ( {z}_{i} , {z}_{i}^{+} ) / τ ) + {\sum }_{j} exp ( sim ( {z}_{i} , {z}_{j}^{-} ) / τ )}$$

where, zᵢ represents a sample i,

$${z}_{i}^{+}$$

represents a positive sample of the sample i,

$${z}_{j}^{-}$$

represents a negative sample of the sample i, and zᵢ includes the entity that needs to be forgotten, sim(·) represents a similarity function, and τ represents temperature hyperparameter.
S32: Forgetting loss function

Specifically targeting the negative sample of the entity that needs to be forgotten, prompting the model to reduce a sensitivity to the entity, and a formula is as follows:

$${ℒ}_{forget} = {\sum }_{k ∈ Forget Entities} {w}_{k} \times sim ( {z}_{i} , {z}_{k}^{-} )$$

where, Wₖ represents a weight of the negative sample of the entity to be forgotten,

$${z}_{k}^{-}$$

represents a feature vector of the negative sample of the entity to be forgotten.
S33: Loss adjustment of forgetting mechanism

For the negative sample of the entity that needs to be forgotten, increasing the weight in the loss function prompts the model to reduce the similarity to the entity, and a weighted loss formula is as follows:

$${ℒ}_{forget} = {\sum }_{k ∈ Forget Entities} {w}_{k} \times sim ( {z}_{i} , {z}_{k}^{-} )$$

$$ℒ = {ℒ}_{contrast} + {λℒ}_{forget}$$

where λ is a forgetting weight coefficient, Wₖ is a weight of the negative sample of the entity to be forgotten, [symbol] _{forget} represents a contrastive loss for the entity to be forgotten, λ represents the forgetting weight coefficient, and controls a strength of forgetting.

An output of a character level network, which represents the vector representation of each sentence in the text, and is used as the input to obtain an output and context vector (i.e. a final hidden state) for each time step through a bidirectional recurrent neural network. A hidden layer dimension is the model hyperparameter, which needs to be adjusted according to a specific dataset and a training process.
S4: Model training: based on the loss value, updating the model parameters through backpropagation to better bring the positive sample closer and the negative sample farther. Repeating this process until the model is converged. After training, the model has stronger entity disambiguation ability and achieves forgetting of specified entities.
S4: Model training includes the following sub steps:
S41: Training strategy

Using appropriate batch sizes to improve training efficiency and stability, adopting learning rate decay or adaptive adjustment strategies to avoid oscillations during the training process, and using methods such as Dropout and weight decay to prevent overfitting.
S42: Backpropagation and Optimization

Using optimization algorithm (Adaptive Moment Estimation with Weight Decay, (AdamW)) to update the model parameters and minimize the loss function.
S43: Model Evaluation

Including entity disambiguation performance evaluation, forgetting effect evaluation, and model generalization ability evaluation.

The present disclosure applies the LLaMA3 model to a task of entity disambiguation and forgetting, combining the large-scale language model with contrastive learning-based entity disambiguation and forgetting methods, which can fully utilize the powerful representation ability of LLaMs, improve the accuracy of entity disambiguation, and achieve effective forgetting of specific entity information. This model: 1. Firstly, the initial text is processed and features are extracted using the LLaMA3 model; 2. The projection layer is added after the output layer of the LLaMA3 model to map the high-dimensional text representation to the contrastive learning space, thereby generating the low dimensional feature representation, which is the numerical vector suitable for contrastive learning; 3. Using the low dimensional feature representation as the input, the contrastive learning module is used to construct the sample pair, including positive and negative sample pairs, and the cosine similarity is then used to calculate similarity. For the positive sample pair, the similarity between the positive sample pair is reduced to enhance the model's ability to recognize the same entity. For the negative sample pair, the similarity between the negative sample pair is extended to improve the model's ability to distinguish different entities, especially the entity that needs to be forgotten. Finally, the loss value and forgetting loss are calculated to obtain the total loss value; 4. Finally, based on the loss value, the model parameter is updated through backpropagation to better bring positive samples closer and negative samples farther. This process is repeated until the model is converged. After training, the model has stronger entity disambiguation ability and also achieves forgetting of specified entities.

The present disclosure adopts self-supervised learning, which does not rely on manually designed features and can automatically learn entity distinguishing features from data; by constructing positive and negative sample pairs, contrastive learning can dynamically learn new entity features, adapt to new contexts, and utilize the powerful representation ability of the large-scale language model to flexibly respond to long tail entities and new knowledge update requirements. Especially in fine-tuning and precise control of the large model, it greatly improves efficiency and expands the limitations of traditional methods.

The present disclosure is described with reference to flowcharts and/or block diagrams of methods, devices (systems), and computer program products according to embodiments of the present disclosure. It should be understood that each process and/or block in a flowchart and/or block diagram, as well as a combination of processes and/or blocks in the flowchart and/or block diagram, can be implemented by computer program instructions. These computer program instructions can be provided to a processor of a general-purpose computer, specialized computer, embedded processor, or other programmable data processing device to generate a machine, such that the instructions executed by the processor of the computer or other programmable data processing device generate a device for implementing the functions specified in one or more processes of the flowchart and/or one or more boxes of the block diagram.

In the description of the present disclosure, it should be understood that terms “first” and “second” are only used for a descriptive purpose and cannot be understood as indicating or implying relative importance or implying the number of technical features indicated. Thus, features limited to “first” and “second” may explicitly or implicitly include one or more of these features. In the description of the present disclosure, “multiple” means two or more, unless otherwise specifically limited.

Obviously, those skilled in the art can make various modifications and variations to the present disclosure without departing from the spirit and scope of the present disclosure. Thus, if these modifications and variations of the present disclosure fall within the scope of the claims and their equivalent technologies, the present disclosure is also intended to include these modifications and variations.

What is claimed is:

1. A method for entity disambiguation and forgetting based on a large language model, comprises steps of:
constructing a contrastive learning sample based on an entity disambiguation dataset and a forgetting dataset, performing data preprocessing to remove irrelevant information; segmenting and encoding text by using a vocabulary of a LLaMA3 model, and generating a dataset;
adding a projection layer and a contrastive learning module for improvement based on the LLaMA3 model, training a model on the dataset to construct the large language model based on improved LLaMA3 model, so that constructed large language model has both entity disambiguation and forgetting capabilities;
in a process of improving the LLaMA3 model, the projection layer is added after an output layer of the LLaMA3 model, a high-dimensional text representation is mapped to a contrastive learning space, modules that requires for contrastive learning are integrated, and this process further comprises a contrastive loss calculation and positive negative sample matching;
in a process of model training, for each sample, a similarity between a feature representation and positive and negative samples is calculated by using cosine similarity, and an effectiveness of the model in distinguishing positive and negative samples is measured by using contrastive loss;
wherein a process of measuring an effectiveness of the model in distinguishing positive and negative samples by using contrastive loss comprises training a model to distinguish positive and negative samples by using InfoNCE loss in a loss function of the contrastive learning, and a formula is as follows:
$${ℒ}_{contrast} = - log \frac{exp ( sim ( {z}_{i} , {z}_{i}^{+} ) / τ )}{exp ( sim ( {z}_{i} , {z}_{i}^{+} ) / τ ) + {\sum }_{j} exp ( sim ( {z}_{i} , {z}_{j}^{-} ) / τ )}$$
wherein zᵢ represents a sample i,
$${z}_{i}^{+}$$
represents a positive sample of the sample i,
$${z}_{j}^{-}$$
represents a negative sample of the sample i, and zᵢ comprises an entity that needs to be forgotten, sim(·) represents a similarity function, and t represents temperature hyperparameter.

2. The method for entity disambiguation and forgetting based on a large language model according to claim 1, wherein in a process of constructing a contrastive learning sample, the contrastive learning sample comprises a positive sample and a negative sample,
wherein the positive sample comprises text of a target entity, a positive sample representation is obtained by encoding using the LLaMA3 model;
the negative samples comprise two types: a first type that is text containing the entity that needs to be forgotten as an object for the model that needs to reduce similarity, and a second type comprising other entities that are easily confused with the target entity.

3. The method for entity disambiguation and forgetting based on a large language model according to claim 1, wherein in a process of constructing the large language model, a forgetting weighted loss function is constructed for the negative sample of the entity that needs to be forgotten;
a weight of the negative sample of the entity that needs to be forgotten in the loss function is increased to prompt the model to reduce the similarity to the entity.

4. The method for entity disambiguation and forgetting based on a large language model according to claim 3, wherein in a process of model training, model parameters are updated through backpropagation based on loss value.

5. An entity disambiguation and forgetting system based on a large language model, which is configured to implement the entity disambiguation and forgetting method based on a large language model according to claim 1, wherein the entity disambiguation and forgetting system comprises:
a data processing module, configured to construct a contrastive learning sample based on an entity disambiguation dataset and a forgetting dataset, perform data preprocessing to remove irrelevant information, segment and encode text by using a vocabulary of a LLaMA3 model, and generate a dataset;
a large language model construction module, configured to add a projection layer and a contrastive learning module for improvement based on the LLaMA3 model; train a model on the dataset to construct the large language model based on improved LLaMA3 model, so that constructed large language model has both entity disambiguation and forgetting capabilities.
